(19) United States
(12) Patent Application Publication
(10) Pub. No.: US 2017/0337854 A1
(43) Pub. Date: Nov. 23, 2017

(54) IDENTIFICATION SYSTEM

(71) Applicant: Ahmet Ersal Mehmet, London (GB)

(72) Inventor: Ahmet Ersal Mehmet, London (GB)

(21) Appl. No.: 15/526,803

(22) PCT Filed: Nov. 13, 2015
(86) PCT No.: PCT/EP2015/076625

§ 371 Date: May 15, 2017

(30) Foreign Application Priority Data
Nov. 13, 2014 (GB) 1420186.7

(51) Int. Cl. G09F 3/20; G09F 3/00; G09F 3/10; G09G 5/00; B60R 13/10; H04W 4/00; G09G 3/34; G06Q 40/00; G06Q 30/00; H04W 64/00; G06Q 40/08

(52) U.S. Cl. CPC G09F 3/208; G09F 3/203; B60R 13/10; G09F 3/0292; G09F 3/10; G09G 5/006; G06Q 40/08; G09G 3/344; G06Q 40/123; G06Q 30/018; H04W 64/00; G09G 2330/02; G09G 2370/16; G09G 2380/10; H04W 4/008; B60Y 2400/216

(57) ABSTRACT

An identification system for providing information regarding an associated object (5), the system comprising a carrier (3) which is provided to the object (5), and display circuitry (7) which is provided to the carrier and displays information regarding the object (5).

The present invention relates to an identification system for and method of providing information regarding an associated object, especially providing information regarding an associated vehicle, such as to the status of road tax, insurance or an MOT.

Traditionally, vehicles have been required a tax disc to be displayed in order to demonstrate that the vehicle was taxed, and in turn had valid insurance and an MOT.

It is an aim of the present invention to provide an identification system for and method of providing information regarding an associated object, especially providing information regarding an associated vehicle, such as to the status of road tax, insurance or an MOT.

In one aspect the present invention provides an identification system for providing information regarding an associated object, the system comprising a carrier which is provided to the object, and display circuitry which is provided to the carrier and displays information regarding the object.

In another aspect the present invention provides an identification system for use with an associated object, the system comprising control circuitry which is provided to the object and includes an interface, wherein the control circuitry is configured to require that the interface of the object is paired to an associated mobile device, and the object remains operative only when the interface of the object is paired to the mobile device at predetermined intervals, optionally within certain time intervals, such as hourly, daily or weekly, or within a certain period prior to use of the object, such as hourly, daily or weekly.

In a further aspect the present invention provides an identification system for use with an associated object, the system comprising control circuitry which is provided to the object and includes an interface, wherein the control circuitry is configured to require that the interface of the object is paired to an associated mobile device at predetermined intervals, optionally within certain time intervals, such as hourly, daily or weekly, or within a certain period prior to use of the object, such as hourly, daily or weekly, and a location is provided to an external monitoring station.

In a still further aspect the present invention provides a method of identifying an object using the above-described identification system.

In a yet further aspect the present invention provides an identification method for providing information regarding an associated object, the method comprising: providing an identification system to an object, the system comprising a carrier, and display circuitry which is provided to the carrier for displaying information regarding the object; and controlling the display circuitry to display information regarding the object.

Preferred embodiments of the present invention will now be described hereinbelow by way of example only with reference to the accompanying drawings, in which:

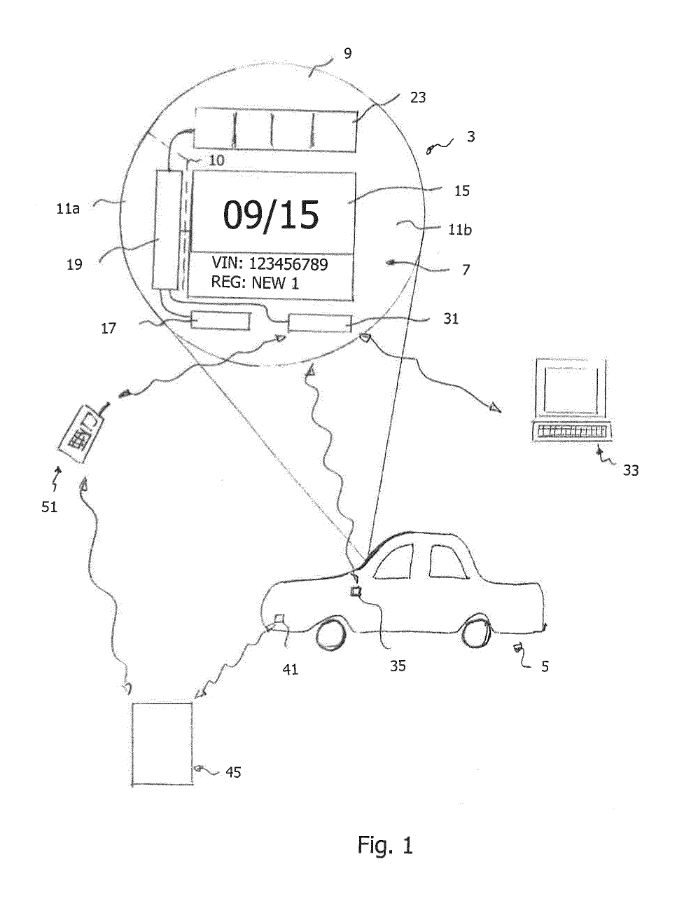

FIG. 1 illustrates a vehicle identification system in accordance with one embodiment of the present invention.

The system comprises a carrier 3 which is affixed to an associated vehicle 5, typically to a windscreen of the vehicle 5, and display circuitry 7 which is provided to the carrier 3 and displays information regarding the vehicle 5, such as to the status of road tax, insurance or an MOT.

In this embodiment the carrier 3 comprises a laminated structure having the display circuitry 7 embedded therein.

In this embodiment the carrier 3 is a self-adhesive element, which is configured on removal to render the system inoperative, such as to prevent subsequent tampering with the system.

In this embodiment the carrier 3 includes a self-adhesive panel 9 which is deformed when removed, here at a perforation 10, such as to break an electrical connection within the display circuitry 7. In this embodiment the panel 9 includes sections 11a, b, here of different adhesive strength, which promote deformation of the panel 9.

In one embodiment the carrier 3 is a flexible element.

In another embodiment the carrier 3 is a rigid element.

In this embodiment the display circuitry 7 comprises a display 15 for displaying information regarding the vehicle 5, a battery 17 for powering the display circuitry 7, and a controller 19 for controlling the display circuitry 7.

In this embodiment the display 15 comprises an electronic ink display.

In this embodiment the battery 17 comprises a re-chargeable battery, but in an alternative embodiment could be a non-rechargeable battery.

In this embodiment the display circuitry 7 further comprises a solar cell 23 which is configured to power the display circuitry 7, and here maintain the battery 17 in a charged state, without requiring an external power source.

The display circuitry 7 further comprises an interface 31 by which information is communicated to and from the display circuitry 7.

In this embodiment the interface 31 is a wireless interface, such as a Bluetooth (RTM) interface by which information is wirelessly communicated to and from the display circuitry 7.

In this embodiment the display circuitry 7 is programmed via the interface 31 using an external device 33, and here by an encrypted communication.

In this embodiment the display circuitry 7 is configured to require that the interface 31 be paired to a corresponding interface 35 in the vehicle 5, such that the display circuitry 7 remains operative only when the interfaces 31, 35 are paired at predetermined intervals, such as within certain time intervals, for example, hourly, daily or weekly.

In this embodiment the interface 35 is a wireless interface, such as a Bluetooth (RTM) interface.

In this embodiment the vehicle 5 includes a transmitter 41 for transmitting a location of the vehicle 5 to an external monitoring station 45, whereby the vehicle 5 can be located by an operative if the vehicle 5 does not have a predetermined, verified status, such as having road tax, insurance or an MOT. In one embodiment the location of the vehicle 5 would only be transmitted when the vehicle 5 does not have a verified status.

In this embodiment the transmitter 41 is a GPS transmitter.

In an alternative embodiment the display circuitry 7 could be configured to require that the interface 31 be paired to a corresponding mobile device 51, such as of the driver, whereby the display circuitry 7 remains operative only when the interface 31 is paired to the mobile device 51 at predetermined intervals, such as within certain time intervals, for example, hourly, daily or weekly, or within a certain period prior to use of the vehicle, for example, hourly, daily or weekly.

In this embodiment the mobile device 51 could transmit a location of the vehicle 5 to the external monitoring station 45, whereby the vehicle 5 can be located by an operative if the vehicle 5 does not have a predetermined, verified status, such as having road tax, insurance or an MOT. In one embodiment the location of the vehicle 5 would only be transmitted when the vehicle 5 does not have the verified status.

Finally, it will be understood that the present invention has been described in its preferred embodiments and can be modified in many different ways without departing from the scope of the invention as defined by the appended claims.

For example, although the present invention has been described in relation to vehicles, the present invention can have application to any object which requires a licence for valid operation, such as a television, where the system could be paired to a mobile device 45 of the owner or user, and the object remains operative only when the interface 31 is paired to the mobile device 51 at predetermined intervals, such as within certain time intervals, for example, hourly, daily or weekly, or within a certain period prior to use of the vehicle, for example, hourly, daily or weekly.

In one embodiment the mobile device 51 could transmit a location of the object to the external monitoring station 45, whereby the object can be located by an operative if the object does not have a predetermined, verified status, such as having a licence. In one embodiment the location of the object would only be transmitted when the object does not have the verified status.

1. An identification system for providing information regarding an associated object, the system comprising a carrier which is provided to the object, and display circuitry which is provided to the carrier and displays information regarding the object.

2. The system of claim 1, wherein the object is a vehicle and the information includes at least one of information regarding road tax, insurance and MOT.

3. The system of claim 1 or 2, wherein the carrier comprises a laminated structure having the display circuitry embedded therein.

4. The system of any of claims 1 to 3, wherein the carrier is a self-adhesive element, which is configured on removal to render the system inoperative, optionally permanently inoperative.

5. The system of claim 4, wherein the carrier includes a self-adhesive panel which is deformed when removed, optionally at a perforation, so as to break an electrical connection within the display circuitry.

6. The system of claim 5, wherein the panel includes sections, optionally of different adhesive strength, which promote deformation of the panel.

7. The system of any of claims 1 to 6, wherein the carrier is a flexible element.

8. The system of any of claims 1 to 6, wherein the carrier is a rigid element.

9. The system of any of claims 1 to 8, wherein the display circuitry comprises a display for displaying information regarding the object, a battery for powering the display circuitry, and a controller for controlling the display circuitry.

10. The system of claim 9, wherein the display comprises an electronic ink display.

11. The system of claim 9 or 10, wherein the battery comprises a re-chargeable battery.

12. The system of any of claims 9 to 11, wherein the display circuitry further comprises a solar cell which is configured to power the display circuitry, and optionally maintain the battery in a charged state, without requiring an external power source.

13. The system of any of claims 1 to 12, wherein the display circuitry further comprises an interface by which information is communicated to and from the display circuitry.

14. The system of claim 13, wherein the interface is a wireless interface, optionally a Bluetooth (RTM) interface, by which information is wirelessly communicated to and from the display circuitry.

15. The system of claim 13 or 14, wherein the display circuitry is programmed via the interface using an external device, optionally by an encrypted communication.

16. The system of any of claims 13 to 15, the display circuitry is configured to require that the interface is paired to a corresponding interface of the object, such that the display circuitry remains operative only when the interfaces of the system and the object are paired at predetermined intervals, optionally within certain time intervals, optionally hourly, daily or weekly.

17. The system of claim 16, wherein the interface of the object is a wireless interface, optionally a Bluetooth (RTM) interface.

18. The system of any of claims 1 to 17, wherein the object includes a transmitter for transmitting a location of the object to an external monitoring station, whereby the object can be located by an operative if the object does not have a predetermined status.

19. The system of claim 18, wherein the location of the object is only transmitted when the object does not have a verified status.

20. The system of claim 18 or 19, wherein the transmitter is a GPS transmitter.

21. The system of any of claims 16 to 20, wherein the display circuitry is configured to require that the interface of the object is paired to an associated mobile device, whereby the display circuitry remains operative only when the interface of the object is paired to the mobile device at predetermined intervals, optionally within certain time intervals, such as hourly, daily or weekly, or within a certain period prior to use of the object, such as hourly, daily or weekly.

22. The system of any of claims 16 to 20, wherein the display circuitry is configured to require that the interface of the object is paired to an associated mobile device, whereby the object remains operative only when the interface of the object is paired to the mobile device at predetermined intervals, optionally within certain time intervals, such as hourly, daily or weekly, or within a certain period prior to use of the object, such as hourly, daily or weekly.

23. The system of claim 21 or 22, wherein the mobile device is configured to transmit a location of the object to the external monitoring station, whereby the object can be located by an operative if the object does not have a predetermined status.

24. The system of claim 23, wherein the location of the object is only transmitted when the object does not have the predetermined status.

25. An identification system for use with an associated object, the system comprising control circuitry which is provided to the object and includes an interface, wherein the control circuitry is configured to require that the interface of the object is paired to an associated mobile device, and the object remains operative only when the interface of the object is paired to the mobile device at predetermined intervals, optionally within certain time intervals, such as hourly, daily or weekly, or within a certain period prior to use of the object, such as hourly, daily or weekly.

26. The system of claim 25, wherein the interface of the object is a wireless interface, optionally a Bluetooth (RTM) interface.

27. The system of claim 25 or 26, wherein the object includes a transmitter for transmitting a location of the object to an external monitoring station, whereby the object can be located by an operative if the object does not have a predetermined status.

28. An identification system for use with an associated object, the system comprising control circuitry which is provided to the object and includes an interface, wherein the control circuitry is configured to require that the interface of the object is paired to an associated mobile device at predetermined intervals, optionally within certain time intervals, such as hourly, daily or weekly, or within a certain period prior to use of the object, such as hourly, daily or weekly, and a location is provided to an external monitoring station.

29. The system of claim 28, wherein the location is communication by the mobile device to the external monitoring station.

30. The system of claim 28, wherein the control circuitry includes a transmitter for communicating the location to the external monitoring station.

31. The system of any of claims 28 to 30, wherein the location is communicated to the external monitoring station only when the interface of the object is not paired to the mobile device at the predetermined interval.

32. The system of any of claims 28 to 31, wherein the interface of the object is a wireless interface, optionally a Bluetooth (RTM) interface.

33. A method of identifying an object using the identification system of any of claims 1 to 32.

34. An identification method for providing information regarding an associated object, the method comprising:
providing an identification system to an object, the system comprising a carrier, and display circuitry which is provided to the carrier for displaying information regarding the object; and
controlling the display circuitry to display information regarding the object.
